(19) United States
(12) Patent Application Publication
(10) Pub. No.: US 2023/0160135 A1
(43) Pub. Date: May 25, 2023

(54) DOOR OF A WASHING MACHINE AND WASHING MACHINE

(71) Applicant: VESTEL ELEKTRONIK SANAYI VE TICARET A.S., Manisa (TR)

(72) Inventors: Suleyman ERDENER, Bayrakli, Izmir (TR); Mesut EFE, Manisa (TR)

(73) Assignee: VESTEL ELEKTRONIK SANAYI VE TICARET A.S., Manisa (TR)

(21) Appl. No.: 17/919,217

(22) PCT Filed: Apr. 15, 2020
(86) PCT No.: PCT/EP2020/060547

§ 371 Date: Oct. 14, 2022

(51) Int. Cl. D06F 39/14; D06F 39/08

(52) U.S. Cl. CPC D06F 39/14; D06F 39/085

(57) ABSTRACT

A door of a washing machine may comprise a main body having an inner section, a side section and an outer section, wherein the side section connects the inner section and the outer section, the side section forms at least sectionally a conical or cylindrical or curved wall, and the main body is preferably transparent for at least visible light. The door may further comprise a connection means for attaching the door to a washing machine, wherein the connection means is arranged at the outer section of the main body, and a locking member for coupling with the washing machine. Furthermore, the side section and/or the outer section comprises at least one fluid channel for guiding pressurized fluid, wherein the fluid channel comprises at least or exactly one input opening and at least or exactly one output opening.

### CROSS-REFERENCE TO RELATED APPLICATIONS

This application is the U.S. national phase of PCT Application No. PCT/EP2020/060547 filed on Apr. 15, 2020, the disclosure of which is incorporated in its entirety by reference herein.

### TECHNICAL FIELD

The present invention refers to a door of a washing machine and to a washing machine and to a method for operating a washing machine.

### BACKGROUND

Washing machines mostly have side glass opening. The place between rubber respectively rubber member and glass respectively main body is mostly full of some waste and chemical dirt although washing process is finished. Mostly the clothes contact this area while taking them out, thus the clothes become dirty again. Furthermore, the user must clean this dirty region.

### SUMMARY

It is the object of the invention to provide a solution that avoids the before mentioned problems. Therefore, it might be a further object to provide a new washing machine door and/or a new washing machine. Furthermore, it might be an object of the present invention to provide a new method for operating a washing machine.

The before mentioned object is solved by a door of a washing machine according to the disclosure. The door of the washing machine preferably comprises at least a main body, having an inner section, a side section and preferably an outer section, wherein the side section connects the inner section and the outer section respectively the inner section is directly coupled with the side section, wherein the side section preferably forms at least sectionally a conical or cylindrical or curved wall. The side section and the inner section preferably form a pot, in particular a wok, like shape. The main body is preferably transparent for at least visible light. The main body is preferably a one-piece element.

The door preferably comprises a connection means for attaching the door to a washing machine, wherein the connection means is arranged at the outer section of the main body or at a holding member, wherein the holding member preferably at least sectionally surrounds the outer section.

The door preferably also comprises a locking member for coupling with the washing machine, in particular for coupling with a locking element of the washing machine, to keep the door in a locked respectively closed position. The locking member is preferably arranged at the outer section of the main body or at the holding member. Thus, the holding member might partially surround the main body and/or might hold the locking member and/or the connection means.

According to the present invention the side section and/or the outer section comprises at least one fluid channel for guiding pressurized fluid, wherein the fluid channel comprises at least or exactly one input opening and at least or exactly one output opening.

This solution is beneficial since pressurized water can be guided via the at least one fluid channel to a target area in which deposit of waste and/or chemical dirt accumulates. Thus, the pressurized water cleans the dirty area, in particular during a washing program of the washing machine.

Further preferred embodiments of the present invention are described in the following specification parts.

The side section and/or the outer section comprises according to a preferred embodiment of the present invention multiple fluid channels for guiding pressurized fluid. This embodiment is beneficial since a high amount of water can be guided via multiple fluid channels to multiple outlets.

Thus, it is also possible to prevent that clothes enter the target area between the main body and the flexible member, in particular the rubber member.

Each fluid channel comprises according to a further preferred embodiment of the present invention at least or exactly one input opening and at least or exactly one output opening. It is alternatively possible that at least one fluid channel comprises multiple output openings. In case of multiple output openings, it is possible that each opening has the same shape and size or that at least two or multiple or the majority or all openings of said fluid channel differ from each other in view of shape and/or size. Additionally or alternatively the side section and/or the outer section comprises at least a first fluid channel and a second fluid channel for guiding pressurized fluid, wherein the first fluid channel is a master fluid channel and the second fluid channel is a branch of the master fluid channel.

One fluid channel or a first set of fluid channels extends according to a further preferred embodiment of the present invention into a first direction and a second fluid channel or a second set of fluid channels extends into a second direction. This embodiment is beneficial since pressurized fluid can be applied to the target area from multiple directions.

At least two fluid channels of the first set of fluid channels differ (from each other) according to a further preferred embodiment of the present invention in length and/or at least two output openings of fluid channels of the first set of fluid channel differ in position and/or orientation. Additionally, or alternatively at least two fluid channels of the second set of fluid channels differ (from each other) in length and/or at least two output openings of fluid channels of the second set of fluid channel differ in position and/or orientation. This embodiment is beneficial since the target area is larger in case pressurized fluid provided via all fluid channels is not applied to the exact same part of the target area. Thus, each fluid jet cleans a predetermined section of the target area.

At least a section of one fluid channel extending between the input opening and one output opening of said fluid channel is according to a further preferred embodiment of the present invention completely arranged inside the side section and/or the outer section. This embodiment is beneficial since the channel respectively channels are covered to prevent damage resulting from high forces which are present inside the washing machine during operation of the washing machine.

At least one fluid channel and preferably multiple fluid channels or all fluid channels is according to a further preferred embodiment of the present invention formed by a pipe or conduit, wherein the pipe or conduit is attached to the side section and/or the outer section. This embodiment is beneficial since the pipes and/or conduits can be manufactured in a prior step. Furthermore, each pipe and/or conduit can be provided with individual respectively exclusive properties, like stiffness, length, diameter and/or material, etc.

The pipe or conduit comprises according to a further preferred embodiment of the present invention the same material as the main body, wherein the material is glass, ceramic or a polymer material or wherein the material comprises glass, ceramic and/or a polymer material. This embodiment is beneficial since the main body can be very stiff respectively rigid.

At least one fluid channel and preferably multiple fluid channels or all fluid channels has according to a further preferred embodiment of the present invention at least in sections and preferably in more than 50% of the length of the fluid channel a circular arc shape respectively extends in more than 50% (length) in a circular arc shape, wherein the circular arc extents more than 90 and preferably more than 120 and highly preferably up to 175. This embodiment is beneficial since pressurized water can be provided in vertical direction above the target area and can be guided via the fluid channel or fluid channels to the target area. The input opening respectively input openings of the fluid channels is/are arranged in vertical direction above the connection means and/or the locking member. The input opening respectively input openings of the fluid channels is/are preferably exactly arranged above the target area in case the door is closed.

The above-mentioned object is also solved by a washing machine. The washing machine according to the present invention preferably comprises at least a main structure, wherein the main structure (28) comprises a receiving chamber for receiving clothes and a door according to any of the preceding claims for closing the receiving chamber. The door is preferably arranged as side door that means preferably not as a top door, thus the washing machine according to the present invention is preferably not a top loader. That door is preferably pivotable around a vertical axis, wherein connection means couples the door to the main structure of the washing machine, wherein the input opening of the at least one fluid channel is arranged above the connection means and wherein the output opening of the at least one fluid channel is preferably arranged below the connection means. The washing machine preferably comprises a pump unit for feeding pressurized fluid via a supply pipe or supply conduit into the input opening of the at least one fluid channel, wherein an output section of the supply pipe or supply conduit is arranged in such a manner that the input opening of the at least one fluid channel can be functionally coupled with the supply pipe or supply conduit by closing the door of the washing machine.

This solution is beneficial since the washing machine according to the present invention requires less human interaction, since there is no need to clean the target area. Thus, the overall comfort is increased. Furthermore, the clothes become cleaner since clothes are prevented from being stuck between the main body and the flexible member.

The pump unit has according to a further preferred embodiment of the present invention an input section for receiving fluid from a fluid source, in particular from the receiving chamber. This embodiment is beneficial since fluid, in particular water, which is in use to clean the clothes inside the receiving chamber, can also be used to clean the target area. However, it is also possible to feed fresh respectively clean fluid, in particular water, to the pump unit, thus, pump unit might be coupled with a fluid, in particular water, source.

The washing machine comprises according to a further preferred embodiment of the present invention a coupling mechanism, in particular a valve member, for connecting the pump unit in a first configuration to the supply pipe or supply conduit and in a second configuration to a drainpipe for draining the fluid from the receiving chamber. This embodiment is beneficial since one pump unit can be used for multiple tasks. Thus, the washing machine can be lighter and less expensive.

The above-mentioned object is also solved by a method for controlling and/or operating a washing machine. The method according to the present invention preferably comprises at least the following steps: Operating a washing machine according to the disclosure, operating the pump unit, wherein the pump unit supplies pressurized fluid to the door, wherein the pressurized fluid is feed into the at least one fluid channel, wherein the at least one fluid channel conducts the fluid to an output opening, wherein the fluid is injected via the output opening of the fluid channel into an target area between a flexible member, in particular a seal or a circumferential seal, and the side section, wherein the flexible member is at least partially pressed against the door.

This method is beneficial since the pressurized fluid, in particular water, can be applied to the target area after a washing program was started or during a washing program and/or after a washing program ended.

The door comprises according to a further preferred embodiment of the present invention multiple fluid channels, wherein each fluid channel has at least one output opening, wherein at least two output openings are arranged on different levels and/or are oriented into different directions.

The pump unit provides according to a further preferred embodiment of the present invention the pressurized fluid with a pressure of more than 1.1 bar or more than 1.2 bar or more than 1.5 bar or more than 2 bar or more than 5 bar or up to 5 bar. This embodiment is beneficial since, high pressure helps to prevent clothes being stuck and helps to remove accumulated dirt in short time.

Further benefits, goals and features of the present invention will be described by the following specification of the attached figures, in which components of the invention are exemplarily illustrated. Components of the devices and method according to the inventions, which match at least essentially with respect to their function, can be marked with the same reference sign, wherein such components do not have to be marked or described in all figures.

The invention is just exemplarily described with respect to the attached figure in the following.

### BRIEF DESCRIPTION OF THE DRAWINGS

FIG. 1 shows an example of a door of a washing machine according to the present invention; and

FIG. 2 shows schematically a washing machine according to the present invention.

### DETAILED DESCRIPTION

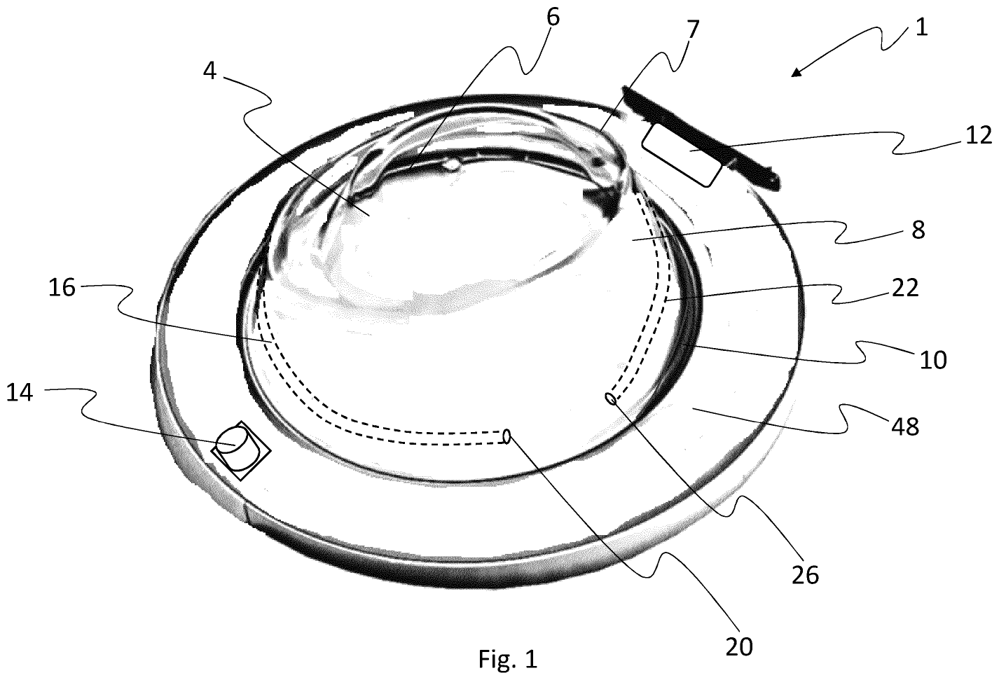

FIG. 1 shows a door 1, in particular a door of a washing machine 2. The door 1 preferably comprises a main body 4, wherein the main body 4 preferably consists or comprises a material which is at least transparent for visible light.

The main body 4 is preferably an element made of glass. The main body preferably has an inner section 6, a side section 8 and highly preferable also an outer section 10, wherein the side section 8 connects the inner section 6 and the outer section 10 or wherein the side section 8 and the inner section 6 are two sections of one element. Preferably the inner section, side section and outer section are sections of one element. Reference number 7 indicates a boundary respectively a connection between the inner section and the side section. The side section preferably has a length of more than 2 cm, in particular of more than 3 cm or 4 cm or 5 cm. Thus, the inner section 6 and the outer section 10 are spaced apart from each other by means of the side section of at least 2 cm. The side section 8 forms at least sectionally a conical or cylindrical or curved wall.

The door 1 preferably comprises a connection means 12 for attaching the door 1 to a washing machine 2, wherein the connection means 12 is preferably arranged at the outer section 10 of the main body 4. The connection means 12, in particular in the form of a glass door hinge, preferably covers the flexible pipe connection.

Additionally, the door 1 preferably comprises a locking member 14 for coupling with the washing machine 2, wherein the locking member 14 is arranged at the outer section 10 of the main body 4. The side section 8 and/or the outer section preferably 10 comprises at least one fluid channel 16 for guiding pressurized fluid, wherein the fluid channel 16 preferably comprises at least or exactly one input opening 18 and at least or exactly one output opening 20. Thus, the main body 4, in particular a glass design, comprises one or multiple pipe holes that will pass pressurized water through its body, wherein the water flow out of the fluid channels or pipes is preferably oriented in different angles.

The example of FIG. 1 shows two fluid channels 16, 22, wherein one fluid channel 16 is arranged on one side of the door center and wherein one fluid channel 22 is arranged on another side of the door center. Both fluid channels 16 and 22 are preferably arranged vis-á-vis. However, it is possible that multiple fluid channels 16, 17, 22, 23 are provided, wherein on one side of the door center is a first number of fluid channels arranged respectively formed and wherein on the other side (opposing side) of the door center is a second number of fluid channels arranged respectively formed. The first number of fluid channels and the second number of fluid channels can be equal or can differ from each other, wherein the first number of fluid channels is preferably higher than 1 and preferably higher than or equal to 2 and wherein the second number of fluid channels is preferably higher than 1 and preferably higher than or equal to 2. Reference numbers 20 and 26 refer to output openings. Fluid, in particular water, exits the fluid channels 16, 22 and therefore the main body 4 via said outlet openings 20, 26.

Reference number 48 indicates a holding member or a holding frame, wherein the connecting means 12 and/or the locking member 14 is/are connected to the holding member 48 or a holding frame.

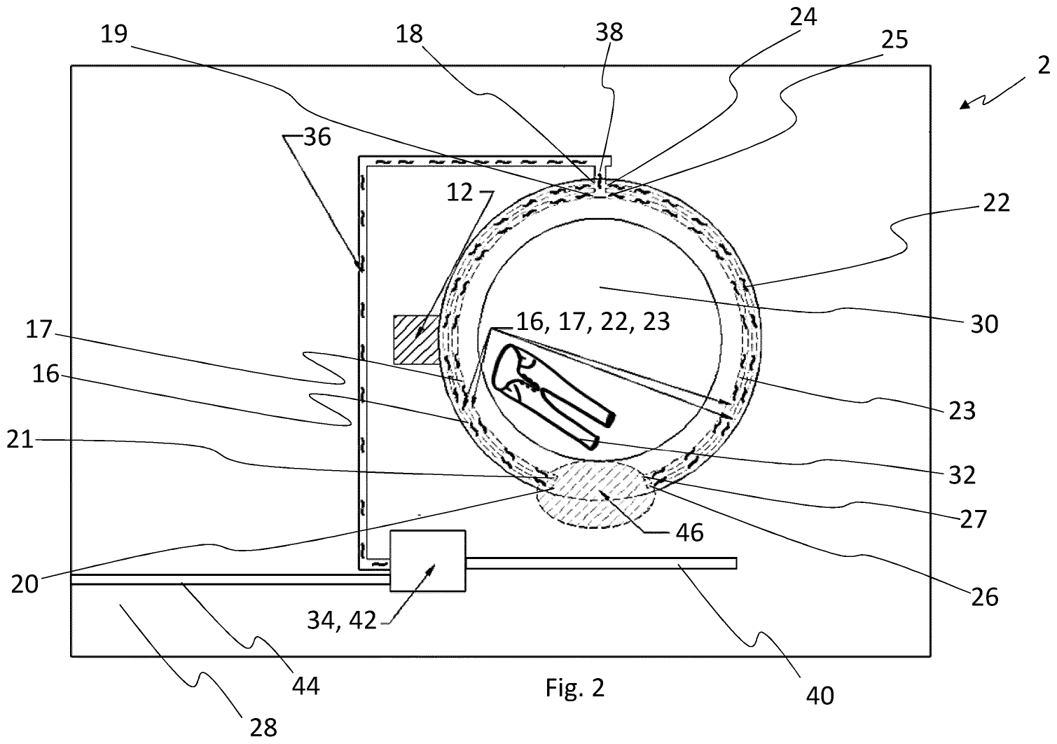

FIG. 2 show schematically an example of a washing machine according to the invention. The washing machine according to the present invention respectively the system according to the present invention comprises a pump 34 that uses the water in the washing machine cabin, wherein said water will be passed to a door 1 according to the present invention, in particular a side glass window, in particular of said door 1, which has several water exits with different angles targeting the polluted area respectively the target area.

Reference number 18 indicates an input opening for inserting fluid, in particular water, into fluid respectively water channel 16 and reference number 20 indicates an output opening of said fluid channel 16.

Reference number 19 indicates an input opening for inserting fluid, in particular water, into fluid respectively water channel 17 and reference number 21 indicates an output opening of said fluid channel 17.

Reference number 24 indicates an input opening for inserting fluid, in particular water, into fluid respectively water channel 22 and reference number 26 indicates an output opening of said fluid channel 22.

Reference number 25 indicates an input opening for inserting fluid, in particular water, into fluid respectively water channel 23 and reference number 27 indicates an output opening of said fluid channel 23.

All or some or multiple input openings 18, 19, 24 and 25 are preferably arranged in such a manner that an output section 38 of pump 34 can be coupled in case the door 1 of the washing machine 2 is closed. Thus, fluid respectively water provided by means of pump unit 34 can be fed via said input openings 18, 19, 24 and 25 inside fluid channels 16, 17, 22, 23. The fluid channels 16, 17, 22, 23 preferably differ from each other preferably in at least one parameter, in particular length, diameter, orientation and/or position of output opening.

The output openings are arranged respectively oriented in such a manner that water can be jetted to a target area, in particular between the side section 8 and an elastic member, in particular a seal.

Reference number 32 schematically indicates clothes which can be present inside the washing machine 2, in particular inside a receiving chamber 30 of the washing machine 2. The washing machine 2 preferably comprises a main structure 28. The main structure 28 respectively housing of the washing machine 2 preferably holds multiple parts of the washing machine 2.

The door 1 is preferably arranged by means of a connection means 12 at the main structure 24 of the washing machine 2.

The pump unit 34 preferably comprises a sucking member respectively an input section 40 for sucking fluid respectively water to the pump unit 34. The pump unit 34 forwards pressurized water via a supply pipe 36 or supply conduit 36 to the fluid channels 16, 17, 22, 23. The pressurized water jets out of the fluid channels 16, 17, 22, 23 for preventing cloths of becoming stuck between the main body 4 and the elastic member. Furthermore, the jetted water causes cleaning of a target area 46.

The output section of pump unit 34 preferably comprises a valve member. The valve member preferably closes the supply pipe 36 or supply conduit 36 in case the door 1 of washing machine 2 is opened. The valve member might be actuated in dependency of an actuation of pump unit 34 and/or in dependency of a door 1 opening and/or door 1 closing event.

A coupling mechanism 42 can be provided for coupling the pump unit 34 to a drainpipe 44 for draining water from the cabinet respectively receiving chamber 30. Thus, it can be possible that the pump unit 34 is used for different tasks.

### LIST OF REFERENCE NUMBERS

1 door of a washing machine
2 washing machine
4 main body
6 inner section
7 boundary between inner section and side section
8 side section
10 outer section
12 connection means
14 locking member
16 fluid channel
17 further fluid channel
18 input opening of fluid channel 16
19 input opening of fluid channel 17
20 output opening of fluid channel 16
21 output opening of fluid channel 17
22 fluid channel of second set
23 further channel of second set
24 input opening of fluid channel 22
25 input opening of fluid channel 23
26 output opening of fluid channel 22
27 output opening of fluid channel 23
28 main structure
30 receiving chamber
32 clothes
34 pump unit
36 supply pipe or supply conduit
38 output section of pump unit
40 input section of pump unit
42 coupling mechanism
44 drainpipe
46 target area
48 holding member

1. A door of a washing machine,
at least comprising:
a main body, having an inner section, a side section and an outer section, wherein the side section connects the inner section and the outer section, wherein the side section forms at least sectionally a conical or cylindrical or curved wall,
a connection means for attaching the door to a washing machine,
a locking member for coupling with the washing machine,
wherein the side section and/or the outer section comprises at least one fluid channel for guiding pressurized fluid, wherein the at least one fluid channel comprises at least or exactly one input opening and at least or exactly one output opening.

2. The door of a washing machine according to claim 1, wherein the at least one fluid channel comprises multiple fluid channels for guiding pressurized fluid.

3. The door of a washing machine according to claim 2, wherein
each fluid channel of the multiple fluid channels comprises at least or exactly one input opening and at least or exactly one output opening
or
the multiple fluid channels comprise at least a first fluid channel and a second fluid channel for guiding pressurized fluid, wherein the first fluid channel is a master fluid channel and the second fluid channel is a branch of the master fluid channel.

4. The door of a washing machine according to claim 2, wherein one fluid channel or a first set of fluid channels of the multiple fluid channels extends into a first direction and a second fluid channel or a second set of fluid channels of the multiple fluid channels extend into a second direction.

5. The door of a washing machine according to claim 4, wherein
at least two fluid channels of the first set of fluid channels differ in length and/or at least two output openings of fluid channels of the first set of fluid channels differ in position and/or orientation
and/or
at least two fluid channels of the second set of fluid channels differ in length and/or at least two output openings of fluid channels of the second set of fluid channels differ in position and/or orientation.

6. The door of a washing machine according to claim 1, wherein at least a section of a fluid channel of the at least one fluid channel extending between an input opening of the at least or exactly one input opening and an output opening of the at least or exactly one output opening is completely arranged inside the side section and/or the outer section.

7. The door of a washing machine according to claim 1, wherein at least one of the at least one fluid channel is formed by a pipe or conduit, wherein the pipe or conduit is attached to the side section and/or the outer section.

8. The door of a washing machine according to claim 7, wherein the pipe or conduit comprises a same material as the main body, wherein the material is glass, ceramic or a polymer material or wherein the material comprises glass, ceramic and/or a polymer material.

9. The door of a washing machine according to claim 1, wherein at least one of the at least one fluid channel has a circular arc shape, wherein the circular arc shape extents more than 90°.

10. A washing machine, at least comprising:
a main structure, wherein the main structure comprises a receiving chamber for receiving clothes,
the door according to claim 1 for closing the receiving chamber,
wherein the door is arranged as a side door,
wherein the connection means couples the door to the main structure of the washing machine,
wherein an input opening of the at least or exactly one input opening of the at least one fluid channel is arranged above the connection means,
and wherein an output opening of the at least or exactly one output opening of the at least one fluid channel is arranged below the connection means, and
a pump unit for feeding pressurized fluid via a supply pipe or supply conduit into the input opening of the at least one fluid channel, wherein an output section of the supply pipe or supply conduit is arranged in such a manner that the input opening of the at least one fluid channel can be functionally coupled with the supply pipe or supply conduit by closing the door of the washing machine.

11. The washing machine according to claim 10, wherein the pump unit has an input section for receiving fluid from a fluid source.

12. The washing machine according to claim 10, wherein the washing machine comprises a coupling mechanism for connecting the pump unit in a first configuration to the supply pipe or supply conduit and in a second configuration to a drain pipe for draining the fluid from the receiving chamber.

13. A method for operating a washing machine,
at least comprising:
operating a washing machine according to claim 10,
operating the pump unit, wherein the pump unit supplies pressurized fluid to the door, wherein the pressurized fluid is feed into the at least one fluid channel,
wherein the at least one fluid channel conducts the fluid to the at least or exactly one output opening,
wherein the fluid is injected via the at least or exactly one output opening of the at least one fluid channel into an target area between a flexible member and the side section, wherein the flexible member is at least partially pressed against the door.

14. The method according to claim 13, wherein the at least one fluid channel of the door comprises multiple fluid channels, wherein each fluid channel has at least one output opening, wherein at least two output openings are arranged on different levels and/or are oriented into different directions.

15. The method according to claim 13, wherein the pump unit provides the pressurized fluid with a pressure of more than 1.1 bar.

16. The door of a washing machine according to claim 1, wherein the main body is transparent for at least visible light.

17. The washing machine according to claim 11, wherein the fluid source comprises the receiving chamber.

18. The washing machine according to claim 12, wherein the coupling mechanism comprises a valve member.

19. The method according to claim 13, wherein the pump unit provides the pressurized fluid with a pressure of more than 2 bar.

20. A door for a washing machine, the door comprising:
a main body having an inner section, a side section and an outer section, wherein the side section connects the inner section and the outer section, the side section forms at least sectionally a conical or cylindrical or curved wall, the side section and/or the outer section comprise/comprises a fluid channel for guiding pressurized fluid, and the fluid channel comprises an input opening and an output opening; and
a hinge for attaching the main body to the washing machine.
